(19) United States
(12) Patent Application Publication
(10) Pub. No.: US 2007/0136740 A1
(43) Pub. Date: Jun. 14, 2007

(54) Method and system for processing sensor data in context-aware system

(76) Inventors: Kang Woo Lee, Daejeon (KR); Han Namgoong, Daejeon (KR); Nam Shik Park, Daejeon (KR); Tae Gun Kang, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/592,356

(22) Filed: Nov. 3, 2006

(30) Foreign Application Priority Data
Dec. 8, 2005 (KR) 2005-119729
Aug. 14, 2006 (KR) 2006-76673

(51) Int. Cl. H04H 9/00; H04N 7/16

(52) U.S. Cl. 725/10; 725/9; 725/12

(57) ABSTRACT

A method and system for processing sensor data in a context-aware system is provided. The system includes: a sensor service collecting the sensor data from a driver of a physical sensor and generating a low level event; an STHQ temporarily storing the generated event and an event generated previously by an event interceptor; and a sensor framework comprised of the event interceptor forming an EIC (event interpretation chain) which interprets the generated event and the event stored in the STHQ and generated previously in connection with each other, and generating or deleting an event or processing the generated event as an event necessary for an upper level application service through an interlocking with the STHQ. The present invention provides active services on the basis of context knowledge inputted from various sensors.

### BACKGROUND OF THE INVENTION

1. Field of the Invention

The present invention relates to a sensor framework, and more particularly, to method and system for processing sensor data in a context-aware system that can provide an active service on the basis of context-aware inputted from a variety of sensors.

2. Description of the Related Art

In a context-aware system, a sensor framework maps sensors in a physical space into a cyber-space on a computer, intercepts context from data of these sensors, and provides the intercepted context to a context manager to support a context-based application such that the context-based application can provide a service actively. All input data from an outside, such as sound data, image data, temperature/humidity sensor data, can be input information for the sensor framework.

The sensor framework has to perform a role of interpretation so as to intercept the context from these input data. To utilize data provided by physical sensors at an application program, the physical sensor does not directly provide such data, but it is necessary to combine various sensor data and provide the combined data as a function of a physical sensor. Additionally, there is needed a method of eliminating data sent from a needless sensor or a method of, when an application needing corresponding information newly is generated, using these sensors without any change of an application program.

Thus, the sensor framework collects low level sensor data coming from the sensor to provide events for providing context necessary for performing context-based application. However, if all events generated by various sensors are transferred to the application without a filtration, overflow may be generated or a system may be overloaded. So, in order to make a context necessary in the application, it is necessary to make a combination of events or to filter meaningless sensor data.

As a related art to the method and system for processing sensor data, there is a Korean Patent Application No. 10-2004-0024833 entitled “System and method for automatically selecting television channel using sensor network”.

The above related art relates to a service in which a set-to-box (STB) installed in a TV automatically perceives a TV viewer using a sensor data to intelligently provide an appropriate TV channel, and the system includes a sensor possessed by each viewer, storing inherent information of each viewer and capable of transmitting information through a wiring or wireless communication, and the STB which receives the inherent information of each viewer to automatically select an allowable channel on the basis of corresponding information.

While the related art provides sensors and modules that can collect, combine and filter sensor data, it fails to teach an efficient management method to provide the context-aware based service using the sensor data.

### SUMMARY OF THE INVENTION

Accordingly, the present invention is directed to method and system for processing sensor data in a context-aware system, which substantially obviate one or more problems due to limitations and disadvantages of the related art.

It is an object of the present invention to provide method and system for processing sensor data in a context-aware system in which a sensor framework including a short-term history queue (STHQ), an event interceptor and a sensor service is established so as to provide a formal method to freely combine, intercept and generate collected sensor data, and an event generated in the past, or several events are interpreted in connection with one another to make a context necessary for storage and application for processing a new event and provide an object and a performance method for filtering and combining the events.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a method for processing sensor data in a context-aware system, the method comprising the steps of: (a) collecting the sensor data from a physical sensor and generating an event from a sensor object mapped on a cyberspace; (b) generating and deleting an event through an EIC (event interpretation chain) comprised of a plurality of event interceptors interpreting the generated event and an event stored in an STHQ and generated previously, or processing the generated event as an event necessary for an upper level application service and storing the same in the STHQ; and (c) delivering the event stored in the STHQ to a context manager such that an application service is executed.

In another aspect of the present invention, there is provided a system for processing sensor data in a context-aware system, the system comprising: a sensor service collecting the sensor data from a driver of a physical sensor and generating a low level event; an STHQ temporarily storing the generated event and an event generated previously by an event interceptor; and a sensor framework comprised of the event interceptor forming an EIC (event interpretation chain) which interprets the generated event and the event stored in the STHQ and generated previously in connection with each other, and generating or deleting an event or processing the generated event as an event necessary for an upper level application service through an interlocking with the STHQ.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 is a conceptual diagram illustrating a structure of a context-aware system according to an embodiment of the present invention;

FIG. 2 is a conceptual diagram illustrating a structure of a sensor framework according to an embodiment of the present invention;

FIG. 3 is a state diagram showing operations of sensor framework elements according to an embodiment of the present invention; and

FIG. 4 is a state diagram showing a performance procedure of an event intercept within a sensor framework according to an embodiment of the present invention.

### DETAILED DESCRIPTION OF THE INVENTION

Reference will now be made in detail to the preferred embodiments of the present invention, examples of which are illustrated in the accompanying drawings.

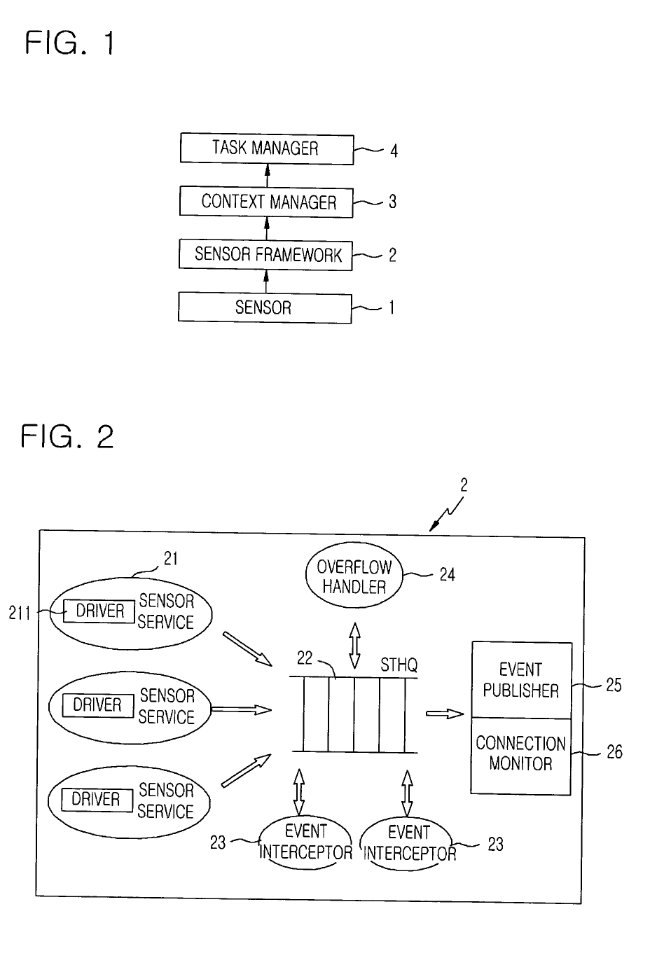

FIG. 1 is a conceptual diagram illustrating a structure of a context-aware system according to an embodiment of the present invention.

Referring to FIG. 1, a sensor framework 2 maps various sensors in a physical space on a cyberspace, intercepts context data from data of these sensors 1 and provide a context manager 3 with the intercepted context data to support a context-based application such that the context-based application can actively provide a service. At this time, the sensor data can have various information formats, such as sound data, image data, temperature/humidity sensor data, user schedule data, etc. Meanwhile, the sensor framework 2 performs a role of interpretation of the context data as well as the role of interception of the context data. In other words, the sensor framework 2 filters and combines the sensor data. The mapping of the sensors 1 in the physical space on the cyberspace is defined as a sensor object, and the term “sensor service” to be mentioned later means the sensor object.

The context manager 3 stores and manages context information transferred from the sensor framework 2, and implicit knowledge deduced on the basis of this context information. The context knowledge managed in this class is referred when a context based application is executed later. Accordingly, the context manager 3 provides functions that the sensor framework adds or corrects the context information, retrieves the context knowledge, and deduces the implicit knowledge, together with a context model for the expression of the context knowledge.

Task manager 4 starts the application with reference to the context knowledge, and manages or controls the context based application process in execution.

FIG. 2 is a conceptual diagram illustrating a structure of a sensor framework according to an embodiment of the present invention.

Referring to FIG. 2, the sensor framework 2 includes a sensor service 21, a short-term history queue (hereinafter referred to as ‘STHQ’) 22, an event interceptor 23, an overflow handler 24, an event publisher 25 and a connection monitor 26.

The sensor service 21 provides a function to collect source sensor data through a driver 211 of a physical sensor and generate a low level event. This service is a soft sensing concept and is tightly coupled to a physical, and an event generated in this sensor service 21 is transferred to the event interrupt 23 for the event interpretation. For example, if an RFID tag is sensed from an RFID antenna, the sensor service generates an event of “TagEntered”.

STHQ 22 is a temporary storage for generating a new event or interpreting the generated event into an event necessary for an upper level application service by connecting and interpreting an event generated previously or several events. STHQ 22 is reconstituted and used as a Queue having a fixed length for the event interpretation. An entry positioned at a mid of the queue may be deleted depending on a filtering result. The event which has been transmitted also continues to be kept in the queue until the queue is interpreted, and is used as the history information while the event is interpreted. All services managed by a service manager share this queue and uses it for an event combination/aggregation. The entry stored in the STHQ 22 has three information of event, time stamp, and delivered. The event is an object representing a generated event, and the time stamp is a point when the event is generated and almost accords with a point when it is inserted into the queue. The delivered is information representing whether or not the event is transferred to the context manger. Since the event that has been transmitted is also stored in the queue if the space of the queue is allowed, and is used as the history information, an effective filtering function can be provided.

The event interceptor 23 provides a function to filter and combine the event so as to make context knowledge necessary for an application. The event interceptor 23 can be included at least one in the sensor framework 2 so as to make the context knowledge which the application service needs commonly. A chain connecting the event interceptors 23 within the sensor framework 2 is referred to as event interpretation chain (hereinafter referred to as ‘EIC’), and the plurality of event interceptors 23 can participate in generating a new event through the EIC. An example of the event interceptor constituting the EIC will be described in FIG. 4. The event interceptors 23 connected through the EIC perform the filtering, combination/aggregation of event, and only the event that has experienced all the event interceptors 23 of the EIC is inserted in the STHQ 22. Each event interceptor 23 can manipulate the event arriving at the STHQ 23 if necessary. The event interceptor 23 provides an event manipulation operation, such as event delete, event transform, event generate, and event delete within the STHQ 22. The sensor framework 2 uses and executes Java Management Extensions (JMX) for the management of the event interceptor 23 and the EIC to enable dynamic add/delete of the interceptor, thus providing a dynamic reconstitution function. Also, it is possible to dynamically change the interceptor sequence within the EIC.

The overflow handler 25 is the event interceptor stored in the last of the EIC, and when the STHQ 22 is overflowed, the overflow handler 25 deletes the event stored in the STHQ 22 or the event which is being tested, to prevent the STHQ 22 from being overflowed. Overflow handler 24 interceptor operates when an event transmission is delayed in a state that many events are generated at the same time or in a state that network is disconnected.

The event publisher 25 functions to transfer the events stored in the STHQ 22 to the context manager 3 of FIG. 1 such that the events stored in the STHQ 22 can be used in a context based application. The connection monitor 26 is an element that can monitor the network state as the context manager having a transfer duty.

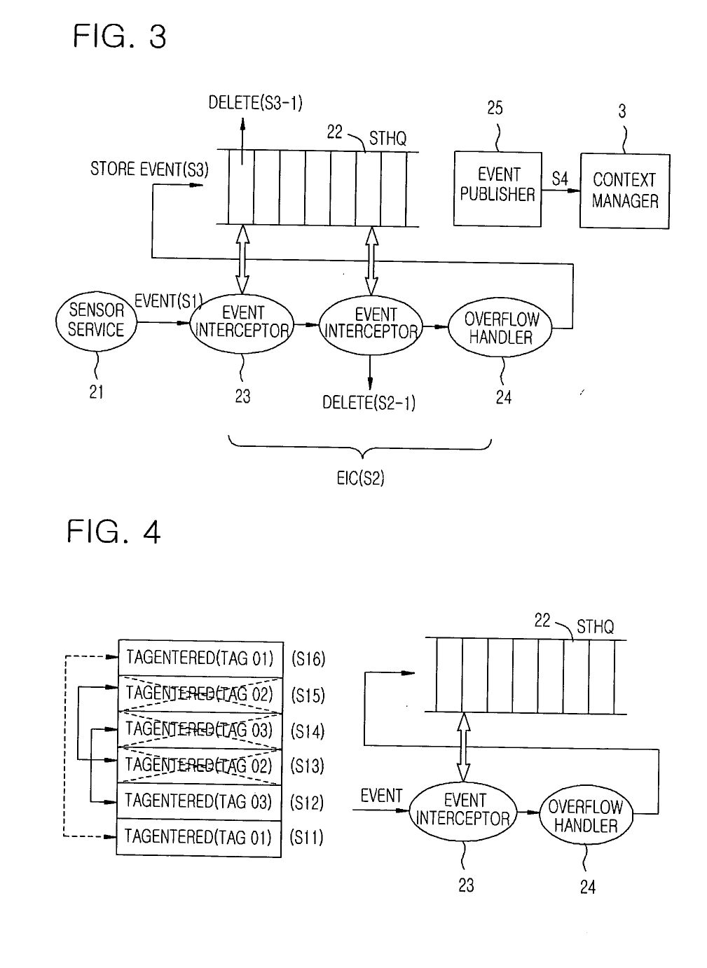

FIG. 3 is a state diagram showing operations of sensor framework elements according to an embodiment of the present invention.

FIG. 3 illustrates that sensor data collected from the sensor are transferred to the context manager so as to be used in the context based application, and in the present embodiment, the task execution procedure is comprised of four steps.

S1: Sensor data are collected from a physical sensor to generate an event. The sensor service 21 collects source sensor data through a driver of the physical sensor to generate a low level event. The generated event is transferred to the first event interceptor 23 of the EIC.

S2: The transferred event is interpreted. The event interceptor 23 provides a function to filter and combine the event through the interpretation of the event so as to make the context knowledge. The event is interpreted while passing through the EIC, and is generated as a new event or deleted (S2-1). A concrete example related with this will be described in FIG. 4.

S3: The event that has passed through both the event interceptor 23 and the overflow handler 24 is stored in the STHQ 22. The STHQ 22 interprets the event generated previously or several events in connection with one another, and is a temporary storage for generating a new event or interpreting the generated event as an event necessary for an upper level application service. The STHQ 22 is a queue having a fixed length while being reconstituted, and an entry positioned at a mid of the queue may be deleted according to a filtering result (S3-1). A concrete example will be described in FIG. 4.

S4: The event stored in the STHQ 22 is transferred to the context manager 3 through a network by the event publisher 25. Thereafter, an application needing a corresponding event will be executed by the task manger.

FIG. 4 is a state diagram showing a performance procedure of an event intercept within a sensor framework according to an embodiment of the present invention.

FIG. 4 shows a delete execution procedure of TagEntered and TagLeft pair by the event interceptor. The event interceptor 23 is a service to interpret the event from the sensor, and the event interceptors registered in the sensor framework form the EIC. In this embodiment, the task execution procedure of TagEntered and TagLeft pair delete event interceptor frequently included in the EIC configuration will be described.

TagEntered and TagLeft are events generated by RFID sensor with information generated by RFID antenna. When sensed Tag information are notified to the RFID sensor service, the RFID antenna observes the state of a corresponding tag to generate TagEntered or TagLeft event. At this time, when the corresponding two tags are the same and two events are all not transmitted, the corresponding event including the event registered in the STHQ 22 is deleted. Referring to FIG. 4, the STHQ 22 has TagEntered event of TagEntered (tag 01) stored in a delivered state (S11). At this time, if TagLeft (tage 03) enters, TagEntered, TagLeft pair delete event interceptor stores the same in the STHQ 22 (S12). Thereafter, if TagEntered (tag 02) event is generated, the TagEntered (tag 02) event is also stored in the STHQ 22 (S13). Thereafter, if TagLeft (03) event is generated and thus enters into TagEntered, TagLeft pair delete event interceptor, the corresponding event deletes the same because the same TagLeft (03) has not been transmitted (S14). This step (S14) corresponds to the example of FIG. 3 (S2-1). Thereafter, when TagLeft (tag 02) enters (S15), since the stored TagEntered (tag 03) (S13) has not been transmitted, it becomes meaningless information and accordingly the two events are all deleted from the queue. The reason is that since a user having tag 02 has entered in a range recognized by a corresponding RFID and then has gone out, it is meaningless to deliver corresponding information. This indicates the case the entry positioned at the mid of the queue is deleted in the intepretation result of the event interceptor described in FIG. 3 (S3-1). On the other hand, if TagLeft (tag 01) enters, it is stored in the STHQ 22 (S16). The reason is that since the TagEntered (tag 01) event has been delivered to the context manager, it is not necessary to deliver the TagLeft (tag 01) event. Accordingly, only the previously transmitted TagEntered (tag 01) event and the TagLeft (tag 01) event exist in the present STHQ 22.

When the present invention is employed in network-based robot applications, external sensing function and external processing function are used through the network, thus capable of overcoming the limitation of the conventional robots and providing various services.

As described above, the method and system for processing sensor data in a context-aware system according to the present invention has the following effects.

First, since external environment change is recognized through sensor and solved though a task execution procedure, it is easy to develop context-based applications.

Also, since a unified interface called sensor service is provided to collect sensor data, it is possible to provide a context-aware system capable of utilizing various information, such as user profile, preference information, schedule information, etc., as well as the physical sensor.

Lastly, since the component for event interpretation can be configured dynamically, it is possible to provide various sensor data.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A method for processing sensor data in a context-aware system, the method comprising the steps of:
(a) collecting the sensor data from a physical sensor and generating an event from a sensor object mapped on a cyberspace;
(b) generating and deleting an event through an EIC (event interpretation chain) comprised of a plurality of event interceptors interpreting the generated event and an event stored in an STHQ and generated previously, or processing the generated event as an event necessary for an upper level application service and storing the same in the STHQ; and
(c) delivering the event stored in the STHQ to a context manager such that an application service is executed.

2. The method of claim 1, wherein the event interceptors are dynamically added and deleted using JMX (Java Management Extensions).

3. The method of claim 2, wherein sequence of the plurality of event interceptors within the EIC is dynamically changed using the JMX.

4. The method of claim 1, wherein in the step (b), only the event that has passed through all the event interceptors is stored in the STHQ.

5. The method of claim 1, wherein when an overflow is generated in the STHQ in the step (b), an overflow handler which is the event interceptor of a last stage deletes the event stored in the STHQ according to a specific policy or deletes the event of a sensor on test.

6. The method of claim 1, wherein when a same tag is inputted in a state that a tag generated in the step (b) does not complete the step (c), the corresponding event interceptor deletes the same tag.

7. The method of claim 1, wherein a tag generated in the step (b) deviates from the physical sensor in a state that the tag generated in the step (b) does not complete the step (c), a same tag is deleted from the corresponding event interceptor and at the same time the generated tag is deleted from the entry of the STHQ.

8. A system for processing sensor data in a context-aware system, the system comprising:
a sensor service collecting the sensor data from a driver of a physical sensor and generating a low level event;
an STHQ temporarily storing the generated event and an event generated previously by an event interceptor; and
a sensor framework comprised of the event interceptor forming an EIC (event interpretation chain) which interprets the generated event and the event stored in the STHQ and generated previously in connection with each other, and generating or deleting an event or processing the generated event as an event necessary for an upper level application service through an interlocking with the STHQ.

9. The system of claim 8, wherein the event interceptor is provided in plurality and has a sequential connection relationship.

10. The system of claim 9, wherein a last event interceptor of the event interceptors an overflow handler which deletes the event stored in the STHQ according to a specific policy or deletes the event of a sensor on test.

11. The system of claim 8, wherein the sensor framework further comprises an event publisher for delivering the event stored in the STHQ to a context manager such that the event stored in the STHQ can be used in a context-based application.

12. The system of claim 8, wherein the sensor framework further comprises a JMX (Java Management Extensions) which performs dynamic add, delete and sequence change of the event interceptor constituting the EIC to reconstitute the EIC.
